(19) United States
(12) Patent Application Publication
(10) Pub. No.: US 2009/0243863 A1
(43) Pub. Date: Oct. 1, 2009

(54) Intrinsically Safe Cellular Tank Monitor For Liquified Gas and Cryogenic Liquids

(75) Inventor: Benjamin N. Lease, Knoxville, TN (US)

Correspondence Address: REINHART BOERNER VAN DEUREN P.C., 2215 PERRYGREEN WAY, ROCKFORD, IL, 61107, US

(73) Assignee: ROBERTSHAW CONTROLS COMPANY, Carol Stream, IL (US)

(21) Appl. No.: 12/059,424

(22) Filed: Mar. 31, 2008

(51) Int. Cl. G08B 21/00

(52) U.S. Cl. 340/618

(57) ABSTRACT

An intrinsically safe cellular tank level monitor for use with consumer LP storage tanks is provided. The cellular monitor is adapted to read the LP storage tank gauge and transmit the level information through a cellular network to a data center. The data center may be part of or may communicate with a fuel delivery service company serving the residential consumer. The cellular monitor is a smart device that allows two-way communication over the cellular network. Control logic within the cellular monitor controls transmission of data to the data center as well as the determination and transmission of alarm conditions as determined by the local cellular monitor.

### FIELD OF THE INVENTION

The present invention relates to tank level monitoring systems, and more particularly to wireless tank level monitoring systems for use with residential fuel tanks such as liquid propane (LP), etc.

### BACKGROUND OF THE INVENTION

While most homes in an urban environment receive natural gas through a centralized distributed system throughout the city for use in heating their homes, most rural homes and farms rely on liquid fuel storage tanks installed on their property to supply the needed fuel for heating, cooking, etc. In such rural environments where a distributed pipeline system does not exist, fuel tank trucks actually deliver the fuel to the individual farms and residences, fill their onsite storage tanks, and leave. The users then draw from the tank as needed to supply their home and outbuildings with heat and for cooking, and occasionally for the generation of electricity. Often, the fuel of choice for these rural installations is liquid propane (LP), although fuel oil, natural gas, etc. may be used based on the installation and equipment installed on the farm or residence.

As the fuel in the storage tank is used for heating, cooking, etc. it will need to be refilled by the tank truck. Typically, there are two arrangements with the fuel company by which refueling is accomplished.

In a first arrangement, a rural customer contracts with the fuel company to make periodic deliveries to refuel the storage tank. Depending on the size of the tank installed at the rural location, such periodic deliveries may be scheduled weekly, monthly, etc. Typically, such deliveries are scheduled so that the customer will not have run out of fuel before the next scheduled delivery is made under an estimated maximum usage of the fuel by that customer. While such a scheduling attempts to preclude the possibility of running out of fuel in the tank, the rural customer pays a premium for such a service. This is because the rural customer often pays a fixed delivery charge regardless of the amount of fuel that is actually refilled into their storage tank. For example, if a warm spell occurs between scheduled deliveries and the user does not consume as much fuel as was estimated in establishing the delivery schedule, the rural user may actually need only a very small amount of fuel. Nonetheless, the user must pay the full delivery charge for having the fuel truck come to the installation.

Despite the premium paid by the user, such a scheduled delivery service also cannot guarantee that the user does not run out of fuel between scheduled deliveries. That is, if a particularly cold snap occurs between the scheduled deliveries or if the user simply uses more fuel during that period than has been typical, there is a possibility that the tank may run empty before the fuel truck returns to refuel the storage tank. As a result, the rural customer may be left without fuel for heating, cooking, etc.

A second type of arrangement between the fuel company and the rural customer is known as a will call arrangement. In such a will call arrangement, the user has responsibility for monitoring the level of fuel remaining in the tank and calling the fuel company to schedule the next delivery to preclude the tank from running empty. In such a will call system, the user is required to periodically check a gauge or dial installed on the storage tank to determine the amount of fuel left in the tank. When the amount of fuel drops below a certain level, the rural customer contacts the fuel company to request a delivery of fuel to refill the storage tank. Many rural customers like this will call arrangement because it minimizes the fixed delivery cost as a proportion of the amount of fuel needed to refill the tank because a delivery is only requested when refilling is necessary.

The problem with such a will call system is that it requires the user to physically go to the storage tank and read a gauge installed thereon. Since the storage tanks are not typically installed in close physical proximity to the residence, and since the largest usage of such fuel occurs during the winter and in extremely cold temperatures, the users are forced to be exposed to such cold temperatures, snow, etc. while they walk to the storage tank, read the gauge, and return to the residence. Because this chore is not pleasant during periods of extreme cold, users often put off checking their tanks. Unfortunately, the rate at which the user consumes this fuel is typically greater than normal during such periods. As a result, many users inadvertently run out of fuel before they can schedule a refill simply because they did not want to experience the unpleasantness of having to hike to their fuel storage tank during such bad weather. As a result, they may be forced to pay an extra emergency delivery charge or endure periods without heat until the delivery truck can return to refuel their storage tank.

To prevent such occurrences from happening and to provide consumers with a convenient method of checking the level fuel remaining in their LP storage tank, the assignee of the instant application developed a wireless tank level monitoring system as described in application Ser. No. 11/117,099, entitled Will Call Wireless Tank Level Monitoring System, the teachings and disclosure of which are incorporated herein in their entireties by reference thereto. This system utilizes wireless, low power radio frequency (RF) communication between a transmitter module and a receiver module installed in the consumer's home. The transmitter module is attached to the LP tank and transmits the tank level information read from the fuel level gauge of the consumer fuel storage tank to the remote display unit mounted within the consumer's dwelling. The user is then able to observe this display from the comfort of the home to determine the level of fuel remaining in the storage tank without having to hike out to the location of the storage tank to read the tank level monitor gauge mounted thereon. Based on the observed reading of the tank level monitor from this display, the consumer could then call to schedule additional fuel deliveries as desired.

While such a system provides significant advantages over prior systems, particularly for consumer comfort and convenience, the requirement of a receiver module mounted within the consumer's dwelling requires access to the consumer's dwelling, particularly during initial installation and trouble-shooting of the system. In certain embodiments of such systems, the receiver also uses a very small amount of the homeowners electricity, as well as occasionally accessing or requiring access to their telephone network either directly or via the requirement that the user contact the fuel supply company to schedule a delivery.

While the benefits of such a system far out weight these draw backs for the vast majority of consumers, for some consumers' privacy concerns and concerns of the increased energy cost of electricity out weight the benefits provided by these systems. Further, requiring access to the consumer's dwelling also requires that the installation and any maintenance of the receiver be scheduled with the homeowner. Since many homeowners work during the day when such installation or service could take place, this requirement often results in lost time from work as the consumer will need to be present during such access to the consumer's dwelling. Further, such systems also have a higher cost of acquisition and ownership due to the need of the receiver module in the first instance. With an increased number of system components, the overall system reliability is also decreased. Further, not all consumer installations allow for such a system to be used because of the distance or location of the LP tank. That is, the low power RF transmitter typically is a short hop radio whose signal cannot carry over long distances, particularly when obstructions, such as outbuildings, are positioned between the transmitter module and the receiver.

As such, there exists a need in the art for a non-intrusive and convenient method for monitoring the fuel supply in an LP fuel storage tank that would ensure that fuel delivery is scheduled to insure continued supply of fuel for residential consumers. Preferably, such a system would not require access to the consumer's dwelling, use of the consumer's electrical and telephone systems, the added expense of a remote module and its associated reduction and overall system reliability, or be limited by the installation location of the LP tank in relation to the consumer's dwelling.

The invention provides such a non-intrusive system and method for monitoring the fuel supply in an LP fuel storage tank and for providing this information to a fuel delivery service to ensure continued supply of fuel for residential consumers. These and other advantages of the invention, as well as additional inventive features, will be apparent from the description of the invention provided herein.

### BRIEF SUMMARY OF THE INVENTION

In view of the above, it is an objective of the present invention to provide a new and improved tank level monitoring system that overcomes the above described and other problems existing in the art. More specifically, it is an objective of the present invention to provide a new and improved intrinsically safe tank level monitoring system that may be used with residential fuel tank installations to provide remote reporting of fuel tank level using a cellular network directly. As such, the intrinsically safe fuel tank level monitoring system alleviates the requirement that a receiver be installed in the consumer's home, which eliminates the usage of the consumer's electricity and phone service, reduces the system component cost, and increases system reliability.

In view of these objectives, an embodiment of the intrinsically safe tank level monitoring system includes an intrinsically safe cellular monitor. Preferably, the cellular monitor is located at or on the fuel storage tank within the Zone 0 hazardous environment surrounding the tank. In a highly preferred embodiment, mounting of the cellular monitor is accommodated on the storage tank, dome, lifting eye or gas line. The cellular monitor uses a transducer that is coupled to a level sensing apparatus, such as a remote-ready tank level gauge, a Hall effect switch, a magneto-resistive sensor, etc. In one embodiment, the cellular monitor continuously reads the output from the sensing apparatus, e.g. the remote-ready level gauge, Hall effect switch, etc., and periodically transmits this information over the cellular network to a data center. Such a data center may be installed at or in communication with the fuel supply company.

In preferred embodiments, however, to extend the operating life in battery operated embodiments, the cellular monitor sleeps, periodically waking to measure the level and transmit the reading to the data center. The cellular monitor in a preferred embodiment is a smart device that includes control logic and allows two-way communication with the data center. This control logic can store user defined alert levels, reporting schedules, etc. The cellular monitor may then determine when a transmission needs to be made outside of the normal reporting schedule, or may govern the reporting all together. For example, the cellular monitor may detect an excessive product usage, which may be indicative of a leak, and contact the data center with an alarm immediately.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 illustrates a simplified operating environment in which the intrinsically safe cellular tank level monitoring system of the present invention finds particular applicability; and

FIG. 2 is an end view illustration of a consumer LP fuel storage tank having an embodiment of the intrinsically safe cellular tank level monitoring system installed thereon illustrating the Zone 0 hazardous location.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

In the description that follows, the system of the present invention will be described in an operating environment in which a rural residential customer utilizes liquid propane (LP) gas for heating, cooking, etc. In this operating environment, the rural customer utilizes an above-ground LP gas storage tank 100 to store the propane that it utilizes to heat his residence 102, with which to cook food, etc. As is typical, the LP storage tank 100 is located on the user's property at a location remote from the dwelling 102 for safety reasons. It should be recognized, however, that the particular type of fuel used by the residential customer is not limiting on the scope of the present invention. Indeed, the tank level sensing system of the present invention may be applied to water level sensing in, e.g., a cistern. As such, this operating environment is provided by way of illustration only, and not by way of limitation. Of course, different types of fuels and other liquids may require different types of fuel level sensing equipment, such equipment being well-known to those skilled in the art.

In one embodiment of the system of the present invention, the level of fuel remaining in the tank 100 is displayed on a tank level gauge 104 that is installed on the fuel storage tank 100. The reading on this tank level gauge 104 is provided by an internal float mechanism provided in the tank 100. In a preferred embodiment of the present invention, this tank level gauge 104 is a remote-ready gauge that provides a ratiometric voltage output proportional to the liquid volume inside the tank. One such remote-ready tank level monitor gauge that may be utilized in an embodiment of the present invention is the Rochester Remote-Ready Dial, R³D, supplied by Rochester Gauges, Inc. This remote-ready dial includes a hall effect module 112 that is designed to snap-fit into a recess in the remote-ready dial lens. Once installed, the module can provide ratiometric voltage output proportional to the liquid volume inside the tank. Other level sensing apparatus may be used, e.g., a Hall effect switch, a magneto resistive sensor, etc. as are well known in the art.

An intrinsically safe cellular monitor 106 is preferably mounted on the tank 100 via a magnet to ensure ease of installation. The cellular monitor 106, which is coupled to the gauge 104 via wire 108, transmits, via a cellular network 114, the tank level information to a data center 110 that may included at or in communication with the fuel supply company. In one embodiment, the cellular monitor 106 utilizes a GSM/GPRS modem, although other modems such as CDMA, EDGE, ORBCOM Satellite Communicator, etc. could be used as well. Preferably, the information and measurements of fuel level will be sent as an SMS message, although such information may be sent using global-gram, GPRS, 1XRTT, EDGE or other IP type protocols. The level measurements will be transmitted only occasionally per the configuration of the cellular monitor 106. For example, the cellular monitor 106 could be programmed to transmit level reading daily. The schedule and other parameters can be remotely adjusted because the communication is two-way.

In addition to having the ability to determine the level of product in the tank 100, the cellular monitor 106 is able to store data and information regarding the product and perform logic operations between information transmission sessions. In such an embodiment, the cellular monitor 106 is provided with, for example, a memory, a processing unit, and/or other components such that the monitor is considered to be a “smart” device.

One such cellular monitor 106 is the Quicksilver™ cellular monitor available from Robertshaw Industrial Products or Maryville, Tenn., which provides only periodic cellular transmissions that may include information regarding many readings, operation of the tank, etc. to minimize the cost of cellular communications. This smart cellular monitor 106 may also include a flexible scheduler such as is described in U.S. Pat. No. 7,249,505, entitled Flexible Scheduler For A Cellular Reporting System, automatic delivery/drain detection such as is described in U.S. Pat. No. 7,298,278, entitled Automatic Delivery/Drain Detection Using A Level Monitoring System, automatic installation verification such as is described in U.S. Pat. No. 7,298,281, entitled System And Method For Verifying Installation Of A Tank Level Monitor, automatic theft detection such as is described in co-pending application Ser. No. 11/199,758, entitled Theft Detection Using A Level Monitoring System, automatic excessive product usage detection such as is described in co-pending application Ser. No. 11/199,982, entitled Excessive Product Usage Detection Using A Level Monitoring System, all assigned to the assignee of the instant application, the teachings and disclosure of which are incorporated herein in their entireties by reference thereto.

The information from the cellular monitor 106 may then be made available to users 118, e.g. the fuel delivery company, the delivery driver, the consumer, etc., via a network 120, such as the Internet. Such users may also be alerted via text messages, email, etc. from the data center 110. This arrangement eliminates the need for a base station receiver installed in the consumer's residence 102, which eliminates the usage of the consumer's electricity and phone system that were previously needed for the user to call to schedule a fuel delivery.

If the consumer were interested in the fuel level, the consumer could simply log on to the Internet and view the information that the cellular monitor 106 has provided, can request an immediate update to the information, and depending on the administrative privileges granted to the particular user, can change user defined parameters such as reporting times, alarm levels, scheduling events, etc. Utilizing such schedules, theft alarms, set points and usage alarms can drastically reduce the amount of communication needed to ensure proper and safe operation and fuel levels and proper delivery and maintenance of the consumer fuel storage tanks. Transmitting information based on such parameters also greatly increases battery life and prolongs operation of the cellular monitor 106.

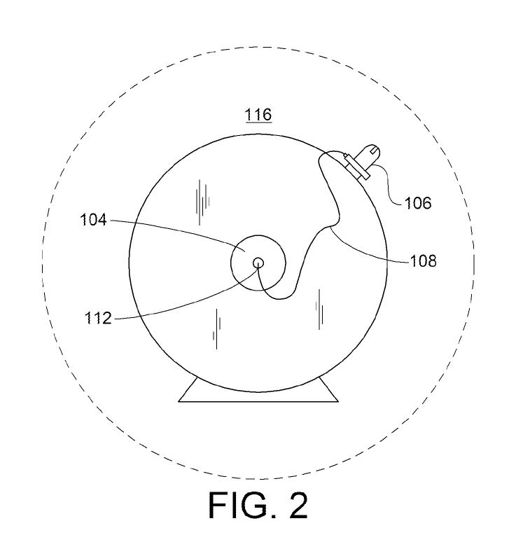

In a preferred embodiment of the present invention, the cellular monitor 106 is connected to the remote-ready gauge 104 via, in a preferred embodiment, a 1.5 meter long wire 108. This wire 108 is sealed at both ends for continuous outdoor operation. The cellular monitor 106 is also designed for continuous outdoor exposure and is certified intrinsically safe for operation in hazardous classified locations with continuous presence of propane vapors in Zone 0 (area 116 illustrated in FIG. 2).

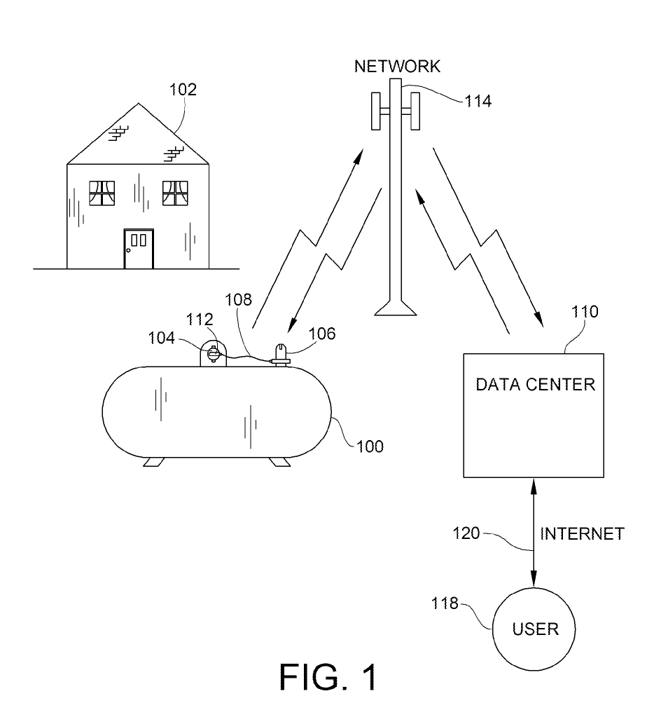

In the embodiment of the cellular monitor 106 illustrated in FIGS. 1-2, the cellular monitor 106 operates on battery power. Since the cellular monitor 106 is designed to operation with the Zone 0 hazardous environment, a preferred embodiment utilizes an intrinsically safe battery pack that limits the maximum voltage and current that can be provided to the device. This battery pack is designed to provide enough battery life for at least one year of operation, and may be readily changed by the consumer. The cellular monitor 106 also includes batter monitoring circuitry that monitors the battery voltage and generates a low battery warning message that may be transmitted to the data center 110 to alert to the need for battery maintenance.

As indicated above, the wire 108 must be suitable for continuous outdoor exposure, and preferably is sealed at both ends. To meet the operating requirements of a typical installation, this wire 108 is preferably a UL approved AWG 24 or larger gage wire. As illustrated in FIG. 2, the cellular monitor 106 interfaces with the gauge 104 via a transducer, e.g. a temperature compensated hall effect module 112. A magnetic coupling between the pointer magnet of the gauge 104 and the Hall effect module 112 is converted into an electrical signal that is read by the cellular monitor 106. This module 112 provides a ratiometric output that is converted within the cellular monitor 106 into a level reading that may be transmitted to the data center 110. In embodiments that utilize other level sensing apparatus, other transducers may be used, e.g. GMR, etc. Depending on whether the storage tank 100 is oriented in a horizontal or a vertical position, the sensor ratiometric output may correspond to a different percentage level reading of fuel in the tank. Therefore, the cellular monitor 106 adjusts for the orientation of the storage tank 100. Alternatively, the setting of the tank orientation and the adjustment thereof may be done in the data center 110.

This data center 110 may be a centralized facility which monitors and reports on numerous consumer tank installations to various fuel delivery companies or locations, may be located at the local delivery company, e.g. a stand alone computer at the fuel supply company that receives information directly from the cellular monitor 106. The computer or data center 110 can comprise a single computer, a server, a network of computers and/or servers, and the like. In general, the data center 110 can comprise almost any device that includes a microprocessor or other computing means. The data center 110 is well suited to make comparisons, store statistics, relay data, display information and/or perform logic calculations relating to the monitoring of tank levels and relaying that information to users, as well as determining the most efficient scheduling of fuel deliveries. This information may be made available to the consumer via the Internet or other means. Upon the occurrence of certain provided conditions, the data center 110 generates an alarm signal (or simply an alarm or signal) that may be displayed or announced locally at the data center 110, or may be relayed to the consumer, route driver, etc.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A fuel level reporting system for use with a consumer liquid propane (LP) fuel tank having a remote ready fuel level gauge disposed thereon, the fuel level gauge having a magnet mechanically coupled to an internal float mechanism, the magnet being oriented by the internal float mechanism as a function of the level of LP contained therein, the LP fuel tank having defined therearound a Zone 0 hazardous environment, comprising:
an intrinsically safe cellular monitor configured to be magnetically attached to the LP fuel tank within the Zone 0 hazardous environment;
a Hall effect module operatively coupled to the cellular monitor and adapted to be attached to the fuel level gauge to determine a position of the magnet, the Hall effect module providing a ratiometric voltage output proportional to the level of fuel in the LP fuel tank;
wherein the cellular monitor is programmed to report fuel level information directly to a data center via a cellular network based on a reporting schedule, and wherein the cellular monitor is further programmed to report fuel level information directly to the data center via the cellular network immediately when the cellular monitor determines a predetermined condition has occurred regardless of the reporting schedule.

2. The fuel level reporting system of claim 1, wherein the cellular monitor reports fuel level information using an SMS message transmitted over the cellular network.

3. The fuel level reporting system of claim 1, wherein the cellular monitor reports fuel level information using a global-gram message transmitted over the cellular network.

4. The fuel level reporting system of claim 1, wherein the cellular monitor reports fuel level information using a GPRS message transmitted over the cellular network.

5. The fuel level reporting system of claim 1, wherein the cellular monitor reports fuel level information using a 1XRTT message transmitted over the cellular network.

6. The fuel level reporting system of claim 1, wherein the cellular monitor reports fuel level information using a EDGE message transmitted over the cellular network.

7. The fuel level reporting system of claim 1, wherein the cellular monitor is configured for two-way cellular communications, and wherein the reporting schedule is derived by the cellular monitor based on information received over the cellular network.

8. The fuel level reporting system of claim 1, wherein the cellular monitor is configured for two-way cellular communications, and wherein the predetermined condition utilizes at least one threshold received over the cellular network.

9. The fuel level reporting system of claim 1, further comprising the data center, and wherein the data center provides the fuel level information to users via a wide area network.

10. The fuel level reporting system of claim 9, the wide area network is the Internet, and wherein the data center provides the fuel level information as a webpage that may be accessed by the users via a thin client interface.

11. The fuel level reporting system of claim 10, wherein the webpage is configured to allow user defined parameter to be entered by the users; and wherein the data center is configured to transmit the user defined parameter to the cellular monitor via the cellular network.

12. A fuel level reporting system, comprising:
a consumer liquid propane (LP) fuel tank having a remote ready fuel level gauge disposed thereon, the fuel level gauge having a magnet mechanically coupled to an internal float mechanism, the magnet being oriented by the internal float mechanism as a function of the level of LP contained therein, the LP fuel tank having defined therearound a Zone 0 hazardous environment;
an intrinsically safe cellular monitor configured to be magnetically attached to the LP fuel tank within the Zone 0 hazardous environment;
a Hall effect module operatively coupled to the cellular monitor and adapted to be attached to the fuel level gauge to determine a position of the magnet, the Hall effect module providing a ratiometric voltage output proportional to the level of fuel in the LP fuel tank;
wherein the cellular monitor is programmed to report fuel level information directly to a data center via a cellular network based on a reporting schedule, and wherein the cellular monitor is further programmed to report fuel level information directly to the data center via the cellular network immediately when the cellular monitor determines a predetermined condition has occurred regardless of the reporting schedule.

13. The fuel level reporting system of claim 12, wherein the cellular monitor is configured for two-way cellular communications, and wherein the reporting schedule is derived by the cellular monitor based on information received over the cellular network.

14. The fuel level reporting system of claim 12, wherein the cellular monitor is configured for two-way cellular communications, and wherein the predetermined condition utilizes at least one threshold received over the cellular network.

15. The fuel level reporting system of claim 12, further comprising the data center, and wherein the data center provides the fuel level information to users via a wide area network.

16. The fuel level reporting system of claim 15, the wide area network is the Internet, and wherein the data center provides the fuel level information as a webpage that may be accessed by the users via a thin client interface.

17. The fuel level reporting system of claim 16, wherein the webpage is configured to allow user defined parameter to be entered by the users; and wherein the data center is configured to transmit the user defined parameter to the cellular monitor via the cellular network.

18. A method of reporting fuel level remaining in a consumer liquid propane (LP) fuel tank having a remote ready fuel level gauge disposed thereon, the fuel level gauge having a magnet mechanically coupled to an internal float mechanism, the magnet being oriented by the internal float mechanism as a function of the level of LP contained therein, the LP fuel tank having defined therearound a Zone 0 hazardous environment, comprising the steps of:
magnetically attaching an intrinsically safe cellular monitor to the LP fuel tank within the Zone 0 hazardous environment;
attaching a Hall effect module that is operatively coupled to the cellular monitor to the fuel level gauge to determine a position of the magnet, the Hall effect module providing a ratiometric voltage output proportional to the level of fuel in the LP fuel tank;
programming the cellular monitor to report fuel level information directly to a data center via a cellular network based on a reporting schedule; and
programming the cellular monitor to report fuel level information directly to the data center via the cellular network immediately when the cellular monitor determines a predetermined condition has occurred regardless of the reporting schedule.

19. The method of claim 18, further comprising the step of sending a message directly to the cellular monitor via the cellular network to vary the reporting schedule.

20. The method of claim 18, further comprising the step of sending a message directly to the cellular monitor via the cellular network to vary parameters upon which the cellular monitor determines the predetermined condition.
